(19) United States
(12) Patent Application Publication
(10) Pub. No.: US 2026/0302877 A1
(43) Pub. Date: Oct. 1, 2026

(54) Motor Assembly for Automotive Air Vent Actuator

(71) Applicant: Ningbo JOYSONQUIN Automotive Systems Holding Co., High-Tech Ningbo (CN)

(72) Inventors: Liao Yan Wen, High-Tech Ningbo (CN); Hu Wen Long, High-Tech Ningbo (CN); Lu Qi Wen, High-Tech Ningbo (CN)

(21) Appl. No.: 19/576,753

(22) Filed: Mar. 24, 2026

(30) Foreign Application Priority Data
Mar. 25, 2025 (CN) 202520526173

(51) Int. Cl. H02K 5/24; H02K 5/15

(52) U.S. Cl. CPC H02K 5/24; H02K 5/15

(57) ABSTRACT

In some embodiments, a motor assembly of an automotive air vent actuator may include a stator assembly. The stator assembly may include a stator housing having a first end and a second end. The motor assembly may include a rotor assembly detachably connected to the stator assembly. The rotor assembly may have a rotor shaft arranged along a first axis and may be detachably connected to the stator housing. The motor assembly may include a bearing. The motor assembly may include an elastic member positioned near the second end of the stator housing and may be configured to support the rotor shaft. The elastic member may be configured to cooperate with the bearing and the second end of the stator housing to continuously apply an elastic force along the first axis to the rotor shaft through the bearing.

### CROSS-REFERENCE TO RELATED APPLICATIONS

This application claims priority to Chinese Patent Application No. CN 202520526173.0, filed on Mar. 25, 2025, the entirety of which is incorporated herein by reference.

### FIELD OF DISCLOSURE

The disclosed systems and methods relate to mechanical and transmission technologies for automotive components. More specifically, the disclosed systems and methods are directed to motor assemblies for automotive air vent actuators.

### BACKGROUND

With the innovative development of the automotive industry, especially the rapid advancement of new energy and autonomous driving technologies, automotive electronics have been widely adopted and become an important component of vehicles. Their performance directly impacts a vehicle's power efficiency, fuel economy, reliability, safety, and comfort.

The working principle of an automotive air vent actuator is as follows: a micro-motor rotates at high speed when energized, decelerates through a gear train, and finally outputs torque and speed via an output gear. This motion is then transmitted through a linkage to drive relevant air flaps, enabling the opening/closing and angular adjustment of the air vents.

In existing technologies, noise issues arise during the operation of flap actuators. One cause is that actuators employing a separable design between the motor rotor and stator typically lack axial limiting mechanisms or only have unilateral limiting. Such structures are prone to generating abnormal sounds during directional changes. Thus, the axial stability and reliability of the rotor require improvement.

### SUMMARY

In some embodiments, an automotive air vent actuator may include an upper housing. The automotive air vent actuator may include a lower housing. The upper housing and the lower housing may define an installation cavity between them. The automotive air vent actuator may include a motor assembly disposed in the installation cavity. The motor assembly may include a stator assembly. The stator assembly may include a stator housing having a first end and a second end. The motor assembly may include a rotor assembly detachably connected to the stator assembly. The rotor assembly may have a rotor shaft arranged along a first axis and may be detachably connected to the stator housing. The motor assembly may include a bearing. The motor assembly may include an elastic member positioned near the second end of the stator housing and configured to support the rotor shaft. The elastic member may be configured to cooperate with the bearing and the second end of the stator housing to continuously apply an elastic force along the first axis to the rotor shaft through the bearing.

In some embodiments, the elastic member may define a central bearing engagement hole surrounded by a plurality of evenly spaced limiting strips. The elastic member may define a peripheral portion including an annular positioning portion. In some embodiments, the elastic member may be disposed on an outer end surface of the second end of the stator housing. The positioning portion of the elastic member may abut the outer end surface. The bearing may be fitted into a housing through-hole defined by a central portion of the second end of the stator housing and into the bearing engagement hole, such that the limiting strips may contact an outer peripheral wall of the bearing. In some embodiments, the positioning portion of the elastic member may be fixedly connected to the outer end surface of the second end of the stator housing. In some embodiments, the positioning portion of the elastic member may be held in place between the outer end surface of the second end of the stator housing and the lower housing. In some embodiments, the elastic member may be disposed on an inner end surface of the second end of the stator housing, a lower end of the bearing may be fitted into a housing through-hole at a central portion of the second end of the stator housing and into the bearing engagement hole, such that a lower end of a bearing shoulder may abut upper surfaces of the limiting strips, and the limiting strips may contact an outer peripheral wall of the bearing.

In some embodiments, the automotive air vent actuator may include a rear cover plate disposed between an outer end surface of the second end of the stator housing and the lower housing. An end portion of the bearing may be fitted into a cover plate through hole at a central portion of the rear cover plate. In some embodiments, the lower housing may define a limiting notch sized and configured to receive the bearing. In some embodiments, an end portion of the bearing may be fitted into the limiting notch.

In some embodiments, the elastic member may include an elastic ring sleeved around an outer peripheral wall of the bearing. In some embodiments, an upper end of the elastic ring may abut a lower end of a bearing shoulder, a lower end of the elastic ring may abut the stator housing, and a lower end of the bearing may be fitted into a housing through-hole at a central portion of the second end of the stator housing. In some embodiments, the elastic member may be made of metal or rubber.

In some embodiments, a motor assembly of an automotive air vent actuator may include a stator assembly. The stator assembly may include a stator housing having a first end and a second end. The motor assembly may include a rotor assembly detachably connected to the stator assembly. The rotor assembly may have a rotor shaft arranged along a first axis and may be detachably connected to the stator housing. The motor assembly may include a bearing. The motor assembly may include an elastic member positioned near the second end of the stator housing and may be configured to support the rotor shaft. The elastic member may be configured to cooperate with the bearing and the second end of the stator housing to continuously apply an elastic force along the first axis to the rotor shaft through the bearing.

In some embodiments, the elastic member may define a central bearing engagement hole surrounded by a plurality of evenly spaced limiting strips. The elastic member may define a peripheral portion including an annular positioning portion. In some embodiments, the elastic member may be disposed on an outer end surface of the second end of the stator housing. The positioning portion of the elastic member may abut the outer end surface. The bearing may be fitted into a housing through-hole defined by a central portion of the second end of the stator housing and into the bearing engagement hole, such that the limiting strips may contact an outer peripheral wall of the bearing. In some embodiments, the positioning portion of the elastic member may be fixedly connected to the outer end surface of the second end of the stator housing. In some embodiments, the positioning portion of the elastic member may be held in place between the outer end surface of the second end of the stator housing and a lower housing of the automotive air vent actuator. In some embodiments, the elastic member may be disposed on an inner end surface of the second end of the stator housing. A lower end of the bearing may be fitted into a housing through-hole at a central portion of the second end of the stator housing and into the bearing engagement hole, such that a lower end of a bearing shoulder may abut upper surfaces of the limiting strips, and the limiting strips may contact an outer peripheral wall of the bearing.

In some embodiments, the motor assembly may include a rear cover plate disposed between an outer end surface of the second end of the stator housing and a lower housing. An end portion of the bearing may be fitted into a cover plate through hole at a central portion of the rear cover plate. In some embodiments, the elastic member may include an elastic ring sleeved around an outer peripheral wall of the bearing. An upper end of the elastic ring may abut a lower end of a bearing shoulder, a lower end of the elastic ring may abut the stator housing, and a lower end of the bearing may be fitted into a housing through-hole at a central portion of the second end of the stator housing. In some embodiments, the elastic member may be made of metal or rubber.

In some embodiments, an automotive air vent actuator may include an upper housing. The automotive air vent actuator may include a lower housing. The upper housing and the lower housing may define an installation cavity between them. The automotive air vent actuator may include a motor assembly disposed in the installation cavity. The motor assembly may include a stator assembly. The stator assembly may include a stator housing having a first end and a second end. The motor assembly may include a rotor assembly detachably connected to the stator assembly. The rotor assembly may have a rotor shaft arranged along a first axis and may be detachably connected to the stator housing. The motor assembly may include a bearing. The motor assembly may include an elastic member positioned near the second end of the stator housing and configured to support the rotor shaft. The elastic member may define a central bearing engagement hole surrounded by a plurality of evenly spaced limiting strips. The elastic member may define a peripheral portion that may include an annular positioning portion. The elastic member may be configured to cooperate with the bearing and the second end of the stator housing to continuously apply an elastic force along the first axis to the rotor shaft through the bearing.

### BRIEF DESCRIPTION OF THE DRAWINGS

The features and advantages of the present disclosure will be more fully disclosed in, or rendered obvious by, the following detailed descriptions of example embodiments. The detailed descriptions of the example embodiments are to be considered together with the accompanying drawings wherein like numbers refer to like parts and further wherein:

FIG. 1 illustrates a cross-sectional view of a first example of a motor assembly for an automotive air vent actuator in accordance with some embodiments;

FIG. 2 illustrates a perspective view of one example of an elastic member in accordance with some embodiments.

FIG. 3 illustrates a cross-sectional view of a second example of a motor assembly for an automotive air vent actuator in accordance with some embodiments;

FIG. 4 illustrates a cross-sectional view of a third example of a motor assembly for an automotive air vent actuator in accordance with some embodiments;

FIG. 5 illustrates a cross-sectional view of a fourth example of a motor assembly for an automotive air vent actuator in accordance with some embodiments;

FIG. 6 illustrates a cross-sectional view of a fifth example of a motor assembly for an automotive air vent actuator in accordance with some embodiments; and

FIG. 7 illustrates a perspective view of an internal structure of one example of a motor assembly for an automotive air vent actuator in accordance with some embodiments.

While the present disclosure is susceptible to various modifications and alternative forms, specific embodiments have been shown by way of example in the drawings and will be described in detail herein. It should be understood, however, that the present disclosure is not intended to be limited to the particular forms disclosed. Rather, the present disclosure is to cover all modifications, equivalents, and alternatives falling within the spirit and scope of the disclosure as defined by the appended claims.

### DETAILED DESCRIPTION

This description of the exemplary embodiments is intended to be read in connection with the accompanying drawings, which are to be considered part of the entire written description. It should be understood, however, that the present disclosure is not intended to be limited to the particular forms disclosed and that the drawings are not necessarily shown to scale. Rather, the present disclosure covers all modifications, equivalents, and alternatives that fall within the spirit and scope of these exemplary embodiments. In the description, relative terms such as “length,” “width,” “upper,” “lower,” “front,” “rear,” “left,” “right,” “vertical,” “horizontal,” “top,” “bottom,” “inner,” “outer,” “clockwise,” “counterclockwise,” “axial,” “planar direction,” “circumferential,” “above,” “below,” “up,” and “down,” as well as derivatives thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected” refer to a relationship wherein structures are secured or attached to one another either directly or indirectly through intervening structures, as well as both movable or rigid attachments or relationships, unless expressly described otherwise. The terms “couple,” “coupled,” “operatively coupled,” “operatively connected,” and the like should be broadly understood to refer to connecting devices or components together either mechanically, or otherwise, such that the connection allows the pertinent devices or components to operate with each other as intended by virtue of that relationship.

The present disclosure pertains to motor assemblies for automotive air vent actuators. In some embodiments, a motor assembly may be arranged in an installation cavity formed by an upper housing and a lower housing of the actuator. The motor assembly may include a stator assembly and a rotor assembly detachably connected to the stator assembly. The stator assembly may include a stator housing with a first end and a second end.

The rotor assembly may include a rotor shaft arranged along a Y-axis direction and may be detachably connected to the stator housing. A bearing and an elastic member may be provided near the second end of the stator housing to support the rotor shaft. The elastic member may cooperate with the bearing and the second end of the stator housing to continuously apply an axial elastic force to the rotor shaft through the bearing.

By adding a bearing and an elastic plate at one end of the rotor shaft, the motor assemblies of the present disclosure may ensure that both ends of the rotor shaft remain in contact with the bearings under high/low temperatures and various operating conditions, which may eliminate axial displacement of the motor rotor and reduce abnormal noise caused by axial collisions.

Advantages of the present disclosure are: (1) axial stability: the bearing and elastic member may ensure continuous contact between the rotor shaft and bearings, which may eliminating axial displacement; (2) noise reduction: the elastic member (e.g., plate/ring) may absorb vibrations, which may significantly reduce abnormal noises from axial collisions; (3) design flexibility: elastic members may be metal (e.g., for high load-bearing) or rubber (e.g., for vibration-damping). Multiple bearing support options (e.g., housing through-hole, cover plate, or limiting notch) may adapt to diverse operational demands; and (4) installation versatility: internal mounting may protect the elastic member from environmental interference. Riveting may simplify assembly and may enhance the structural integrity. Further, space optimization between stator and lower housings may reduce cost.

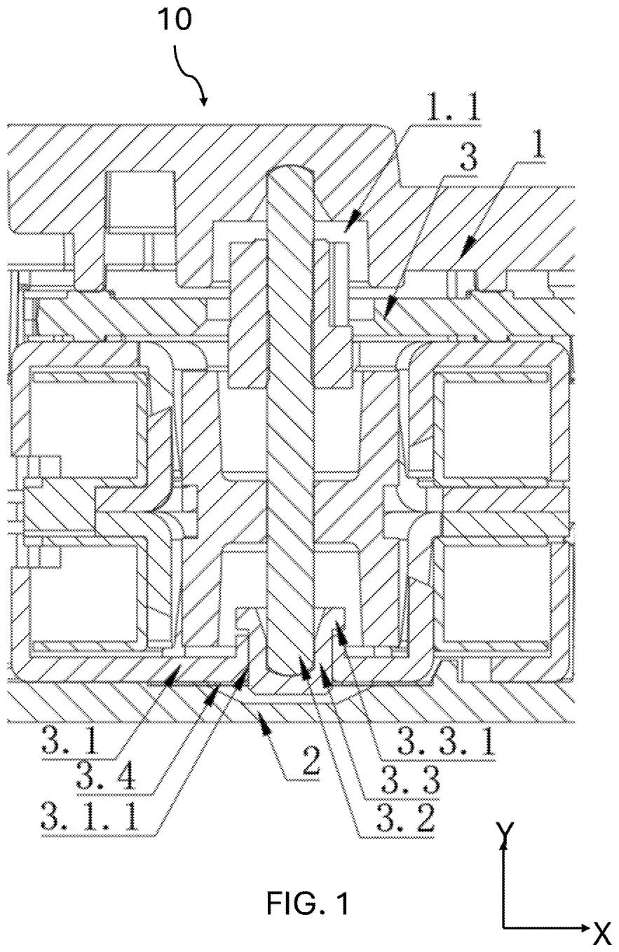

Turning now to the figures, FIG. 1 illustrates a cross-sectional view of a first example of a motor assembly 3 for an automotive air vent actuator 10 in accordance with some embodiments. The automotive air vent actuator 10 may include an upper housing 1, a lower housing 2, and the motor assembly 3. The upper housing 1 may define a shaft notch 1.1. The upper housing 1 may be coupled to the lower housing 2 such that a cavity is formed between them. The motor assembly 3 may be disposed in the cavity formed between the upper housing 1 and the lower housing 2.

The motor assembly 3 may include a stator assembly having a stator housing 3.1 that may extend between a first end and a second end. The stator housing 3.1 may define a through hole 3.1.1. The motor assembly 3 may include a rotor assembly having a rotor shaft 3.2. The rotor shaft 3.2 may be arranged such that it extends along a first axis, which in FIG. 1 is labeled as the Y-axis. In some embodiments, the rotor shaft 3.2 may be detachable from the stator housing 3.1.

In some embodiments, the automotive air vent actuator 10 may include a bearing 3.3 and an elastic member 3.4 disposed near an end of the stator housing 3.1. The elastic member 3.4 may cooperate with the bearing 3.3 to apply a continuous axial force to the rotor shaft 3.2. The rotor shaft 3.2 may rotate within the shaft notch 1.1 of the upper housing, and may be supported by the bearing 3.3.

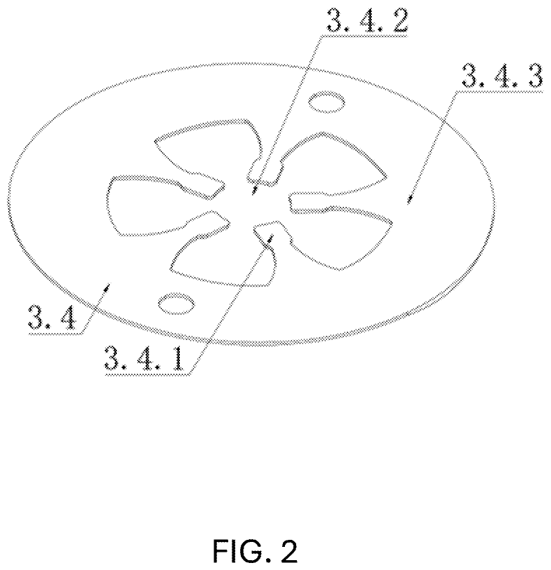

FIG. 2 illustrates a perspective view of one example of an elastic member 3.4 in accordance with some embodiments. The elastic member 3.4 may define a central bearing engagement hole 3.4.2 enclosed by spaced limiting strips 3.4.1 and a peripheral positioning portion 3.4.3. The elastic member 3.4 may be mounted on the stator housing's 3.1 outer end surface, with its positioning portion 3.4.3 abutting the stator housing 3.1. In some embodiments, an end of the stator housing 3.1 may be fixedly connected to the elastic member's 3.4 positioning portion 3.4.3. The bearing 3.3 may be fitted into the through-hole 3.1.1 and the bearing engagement hole 3.4.2, which may ensure contact between the limiting strips 3.4.1 and the bearing's 3.3 outer wall.

In some embodiments, the elastic member 3.4 may be or include an elastic plate that defines the bearing engagement hole 3.4.2 at its center enclosed by evenly spaced limiting strips 3.4.1. In some embodiments, the annular positioning portion 3.4.3 is disposed near the periphery of the elastic member 3.4. In some embodiments, the elastic member 3.4 may be mounted on the outer end surface of an end of the stator housing 3.1. In some embodiments, the positioning portion 3.4.3 may abut the stator housing 3.1 while the bearing 3.3 is fitted into a housing through-hole 3.1.1 and the bearing engagement hole 3.4.2, which may ensure contact between the limiting strips 3.4.1 and the bearing's 3.3 outer wall. In some embodiments, an end of the stator housing 3.1 may be fixedly connected to the positioning portion 3.4.3 of the elastic member 3.4.

In some embodiments, the stator housing 3.1 and elastic member 3.4 may be detachably connected, with the lower housing 2 limiting the positioning portion 3.4.3. In some embodiments, the elastic member 3.4 may be installed on the stator housing's 3.1 inner end surface, with the bearing's 3.3 shoulder abutting the limiting strips 3.4.1. In some embodiments, the air vent actuator 10 may include a rear cover plate between the stator housing 3.1 and lower housing 2, with the bearing 3.3 fitted into a cover plate through-hole. In some embodiments, the lower housing 2 may define a limiting notch to secure the bearing 3.3. In some embodiments, the elastic member 3.4 may be an elastic ring sleeved on the bearing's 3.3 outer wall, which may provide axial support via elastic deformation. In some embodiments, the elastic member 3.4 may be made of metal (e.g., for high strength/precision) or rubber (e.g., for vibration damping).

Referring back to FIG. 1, during assembly of the motor assembly, the elastic member 3.4 may be riveted to the stator housing's 3.1 outer end surface. The stator housing 3.1 may be installed in the lower housing 2. The bearing 3.3 may be inserted into the through-hole 3.1.1, which may ensure contact with the limiting strips 3.4.1. The rotor shaft 3.2 may be connected to the bearing 3.3 and disposed in the shaft notch 1.1 of the upper housing 1.

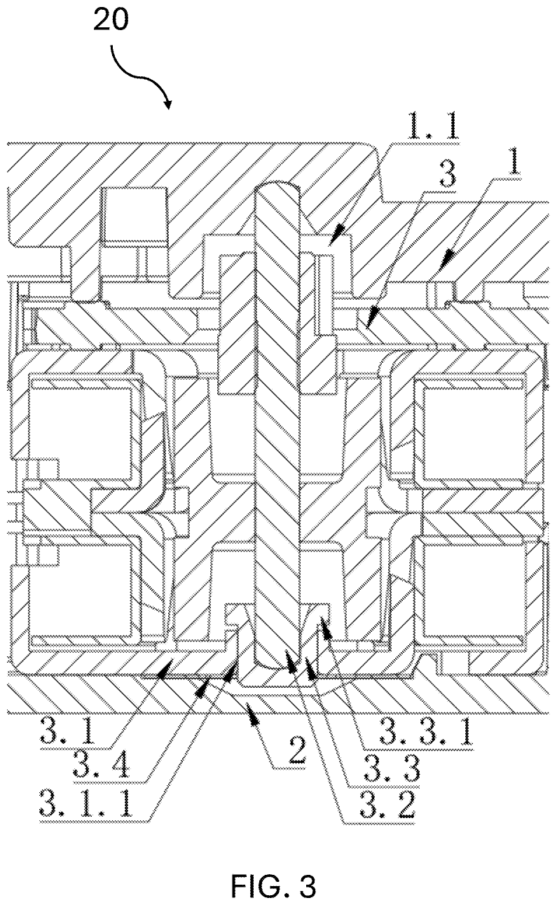

FIG. 3 illustrates a cross-sectional view of a second example of a motor assembly 3 for an automotive air vent actuator 20 in accordance with some embodiments. The automotive air vent actuator 20 may include the same or similar features as automotive air vent actuator 10 discussed above, which is not repeated herein for brevity. In some embodiments, the elastic member 3.4 may be detachably connected to the stator housing 3.1. The lower housing 2 and stator housing 3.1 together may limit the elastic member's 3.4 position. During assembly, the elastic member 3.4 may be placed in the cavity between the upper housing 1 and the lower housing 2. The elastic member 3.4 may abut the lower housing 2 and the stator housing 3.1. The bearing 3.3 and the rotor shaft 3.2 may be installed as discussed above for the automotive air vent actuator 10.

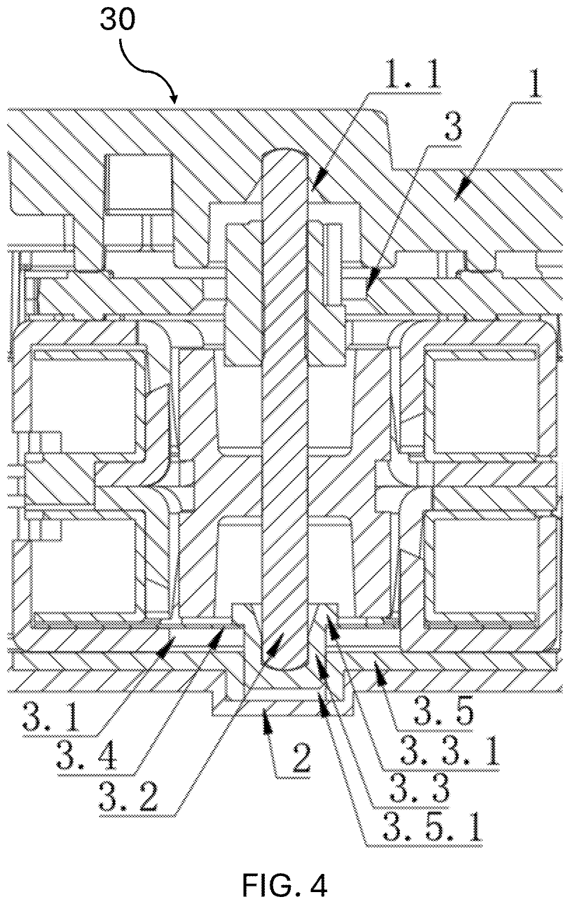

FIG. 4 illustrates a cross-sectional view of a third example of a motor assembly 3 for an automotive air vent actuator 30 in accordance with some embodiments. The automotive air vent actuator 30 may include the same or similar features as automotive air vent actuator 10 and/or 20 discussed above, which is not repeated herein for brevity. The elastic member 3.4 may be mounted on the stator housing's 3.1 inner end surface. The bearing 3.3 may be fitted into the through-hole 3.1.1 and bearing engagement hole 3.4.2. The bearing's 3.3 shoulder 3.3.1 may abut the limiting strips 3.4.1. In some embodiments, the automotive air vent actuator 30 may include a rear cover plate 3.5 that defines a cover plate through-hole 3.5.1. The bearing 3.3 may extend into the cover plate through-hole 3.5.1. During assembly, the rear cover plate 3.5 may be installed on the stator housing's 3.1 outer end. The elastic member 3.4 may be positioned inside the stator housing 3.1. The bearing 3.3 may be inserted through the elastic member 3.4 and cover plate 3.5.

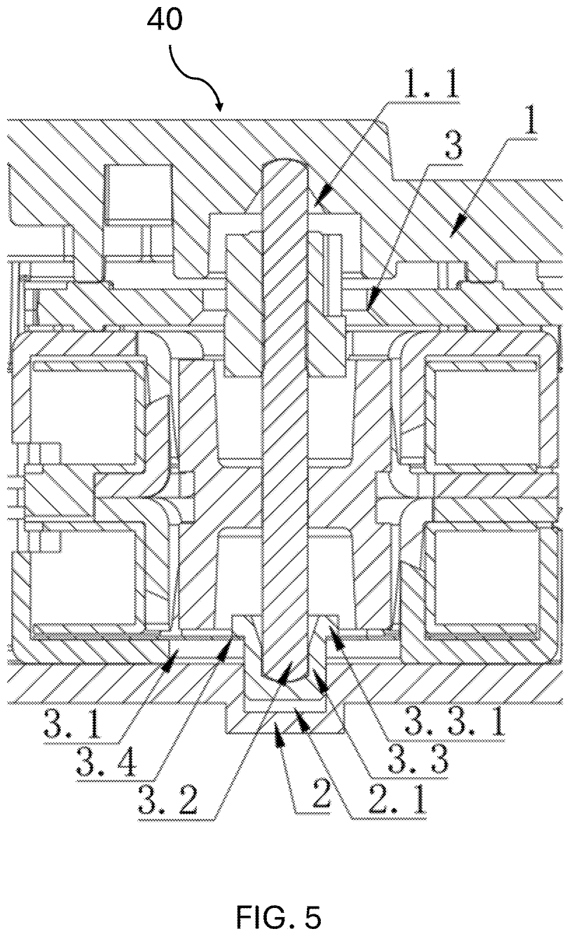

FIG. 5 illustrates a cross-sectional view of a fourth example of a motor assembly 3 for an automotive air vent actuator 40 in accordance with some embodiments. The automotive air vent actuator 40 may include the same or similar features as automotive air vent actuator 10, 20, and/or 30 discussed above, which is not repeated herein for brevity. The bearing 3.3 may be secured in a limiting notch 2.1 defined by the lower housing 2.

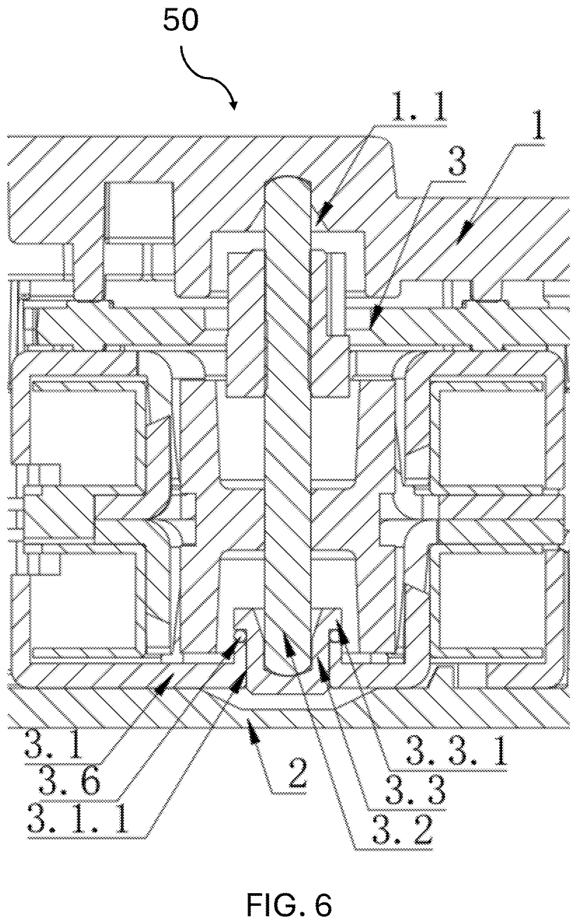

FIG. 6 illustrates a cross-sectional view of a fifth example of a motor assembly 3 for an automotive air vent actuator 50 in accordance with some embodiments. The elastic member 3.4 may be an elastic ring 3.6 sleeved on the bearing 3.3. In some embodiments, the elastic ring 3.6 may be made of a rubber material. The elastic ring 3.6 may abut the bearing shoulder 3.3.1 and stator housing 3.1 to provide an axial force.

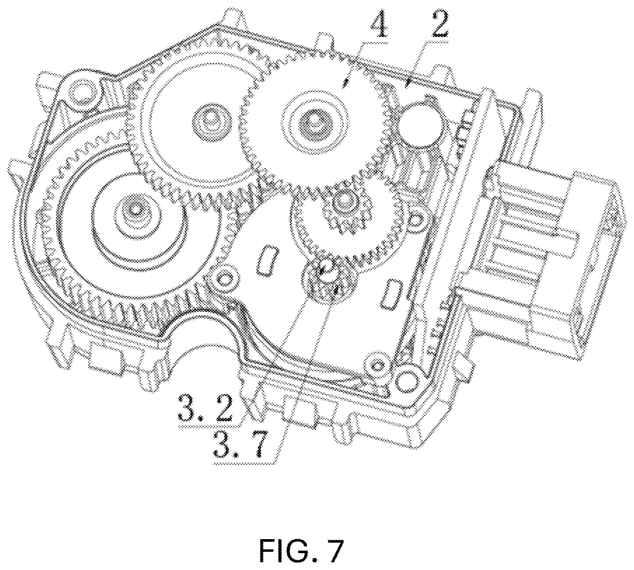

FIG. 7 illustrates a perspective view of an internal structure of one example of a motor assembly 3 for an automotive air vent actuator 10, 20, 30, 40, and/or 50 in accordance with some embodiments. The actuator (e.g., automotive air vent actuator 10, 20, 30, 40, and/or 50) may include a gear transmission assembly 4. The gear transmission assembly 4 may include one or more gears used to operate the automotive air vent actuator 10, 20, 30, 40, and/or 50. The one or more gears of the gear transmission assembly 4 may be driven by a drive gear 3.7 on the rotor shaft 3.2.

The labels in the figures are as follows:

1. Upper housing; 1.1. Shaft notch; 2. Lower housing; 2.1. Limiting notch; 3. Motor assembly; 3.1. Stator housing; 3.1.1. Housing through-hole; 3.2. Rotor shaft; 3.3. Bearing; 3.3.1. Bearing shoulder; 3.4. Elastic member; 3.4.1. Limiting strips; 3.4.2. Bearing engagement hole; 3.4.3. Positioning portion of the elastic member; 3.5. Rear cover plate; 3.5.1. Cover plate through-hole; 3.6. Elastic ring; 3.7. Drive gear; 4. Gear transmission assembly.

### Features of the Disclosure

In some embodiments, a motor assembly for an automotive air vent actuator may include a motor assembly disposed in an installation cavity formed by an upper housing and a lower housing of the actuator. The motor assembly may include a stator assembly and a rotor assembly detachably connected to the stator assembly. The stator assembly may include a stator housing having a first end and a second end. The rotor assembly may include a rotor shaft arranged along a Y-axis direction and may be detachably connected to the stator housing. The motor assembly may include a bearing and an elastic member provided near the second end of the stator housing to support the rotor shaft. The elastic member may cooperate with the bearing and the second end of the stator housing to continuously apply an elastic force along the Y-axis direction to the rotor shaft through the bearing.

In some embodiments, the elastic member may be an elastic plate. A center of the elastic plate may be provided with a bearing engagement hole enclosed by a plurality of evenly spaced limiting strips. A peripheral portion of the elastic plate may be provided with an annular positioning portion.

In some embodiments, the elastic plate may be disposed on an outer end surface of the second end of the stator housing. The positioning portion of the elastic plate may abut against the outer end surface of the second end of the stator housing. The bearing may be sequentially fitted into a housing through-hole at a central portion of the second end of the stator housing and the bearing engagement hole, such that the limiting strips abut against an outer peripheral wall of the bearing.

In some embodiments, the outer end surface of the second end of the stator housing may be fixedly connected to the positioning portion of the elastic plate.

In some embodiments, the outer end surface of the second end of the stator housing may be connected to the positioning portion of the elastic plate. The lower housing may cooperate with the outer end surface of the second end of the stator housing to limit the positioning portion of the elastic plate.

In some embodiments, the elastic plate may be disposed on an inner end surface of the second end of the stator housing. A lower end of the bearing may be sequentially fitted into a housing through-hole at a central portion of the second end of the stator housing and the bearing engagement hole, such that a lower end of a bearing shoulder abuts against upper end surfaces of the limiting strips, and the limiting strips abut against an outer peripheral wall of the bearing.

In some embodiments, the motor assembly may include a rear cover plate disposed between the outer end surface of the second end of the stator housing and the lower housing of the actuator. An end portion of the bearing may be further fitted into a cover plate through-hole at a central portion of the rear cover plate.

In some embodiments, the lower housing may be provided with a limiting notch corresponding to the bearing. An end portion of the bearing may be further fitted into the limiting notch.

In some embodiments, the elastic member may include an elastic ring sleeved on the outer peripheral wall of the bearing, such that an upper end of the elastic ring abuts against a lower end of a bearing shoulder, a lower end of the elastic ring abuts against the stator housing, and a lower end of the bearing is fitted into a housing through-hole at a central portion of the second end of the stator housing.

In some embodiments, the elastic member may be made of metal or rubber.

It may be emphasized that the above-described embodiments, particularly any “preferred” embodiments, are merely possible examples of implementations, set forth for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure.

While this specification contains many specifics, these should not be construed as limitations on the scope of any disclosures, but rather as descriptions of features that may be specific to a particular embodiment. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments.

Although the disclosure has been described in terms of exemplary embodiments, it is not limited thereto. Rather, the appended claims should be construed broadly, to include other variants and embodiments of the disclosure, which may be made by those skilled in the art without departing from the scope and range of equivalents of the disclosure. Also, this disclosure covers all non-essential modifications or direct applications of its technical solutions to other scenarios.

What is claimed is:

1. An automotive air vent actuator, comprising:
an upper housing;
a lower housing, the upper housing and the lower housing defining an installation cavity between them;
a motor assembly disposed in the installation cavity, the motor assembly comprising:
a stator assembly, the stator assembly including a stator housing having a first end and a second end; and
a rotor assembly detachably connected to the stator assembly, the rotor assembly having a rotor shaft arranged along a first axis and detachably connected to the stator housing;
a bearing; and
an elastic member positioned near the second end of the stator housing and configured to support the rotor shaft,
wherein the elastic member is configured to cooperate with the bearing and the second end of the stator housing to continuously apply an elastic force along the first axis to the rotor shaft through the bearing.

2. The automotive air vent actuator of claim 1, wherein the elastic member defines a central bearing engagement hole surrounded by a plurality of evenly spaced limiting strips, and a peripheral portion including an annular positioning portion.

3. The automotive air vent actuator of claim 2, wherein the elastic member is disposed on an outer end surface of the second end of the stator housing, wherein the positioning portion of the elastic member abuts the outer end surface, and wherein the bearing is fitted into a housing through-hole defined by a central portion of the second end of the stator housing and into the bearing engagement hole, such that the limiting strips contact an outer peripheral wall of the bearing.

4. The automotive air vent actuator of claim 3, wherein the positioning portion of the elastic member is fixedly connected to the outer end surface of the second end of the stator housing.

5. The automotive air vent actuator of claim 3, wherein the positioning portion of the elastic member is held in place between the outer end surface of the second end of the stator housing and the lower housing.

6. The automotive air vent actuator of claim 2, wherein the elastic member is disposed on an inner end surface of the second end of the stator housing, and a lower end of the bearing is fitted into a housing through-hole at a central portion of the second end of the stator housing and into the bearing engagement hole, such that a lower end of a bearing shoulder abuts upper surfaces of the limiting strips, and the limiting strips contact an outer peripheral wall of the bearing.

7. The automotive air vent actuator of claim 6, further comprising a rear cover plate disposed between an outer end surface of the second end of the stator housing and the lower housing, wherein an end portion of the bearing is fitted into a cover plate through hole at a central portion of the rear cover plate.

8. The automotive air vent actuator of claim 6, wherein the lower housing defines a limiting notch sized and configured to receive the bearing, and an end portion of the bearing is fitted into the limiting notch.

9. The automotive air vent actuator of claim 1, wherein the elastic member comprises an elastic ring sleeved around an outer peripheral wall of the bearing, wherein an upper end of the elastic ring abuts a lower end of a bearing shoulder, a lower end of the elastic ring abuts the stator housing, and a lower end of the bearing is fitted into a housing through-hole at a central portion of the second end of the stator housing.

10. The automotive air vent actuator of claim 1, wherein the elastic member is made of metal or rubber.

11. A motor assembly of an automotive air vent actuator, comprising:
a stator assembly, the stator assembly including a stator housing having a first end and a second end; and
a rotor assembly detachably connected to the stator assembly, the rotor assembly having a rotor shaft arranged along a first axis and detachably connected to the stator housing;
a bearing; and
an elastic member positioned near the second end of the stator housing and configured to support the rotor shaft,
wherein the elastic member is configured to cooperate with the bearing and the second end of the stator housing to continuously apply an elastic force along the first axis to the rotor shaft through the bearing.

12. The motor assembly of claim 11, wherein the elastic member defines a central bearing engagement hole surrounded by a plurality of evenly spaced limiting strips, and a peripheral portion including an annular positioning portion.

13. The motor assembly of claim 12, wherein the elastic member is disposed on an outer end surface of the second end of the stator housing, wherein the positioning portion of the elastic member abuts the outer end surface, and wherein the bearing is fitted into a housing through-hole defined by a central portion of the second end of the stator housing and into the bearing engagement hole, such that the limiting strips contact an outer peripheral wall of the bearing.

14. The motor assembly of claim 13, wherein the positioning portion of the elastic member is fixedly connected to the outer end surface of the second end of the stator housing.

15. The motor assembly of claim 13, wherein the positioning portion of the elastic member is held in place between the outer end surface of the second end of the stator housing and a lower housing of the automotive air vent actuator.

16. The automotive air vent actuator of claim 12, wherein the elastic member is disposed on an inner end surface of the second end of the stator housing, and a lower end of the bearing is fitted into a housing through-hole at a central portion of the second end of the stator housing and into the bearing engagement hole, such that a lower end of a bearing shoulder abuts upper surfaces of the limiting strips, and the limiting strips contact an outer peripheral wall of the bearing.

17. The motor assembly of claim 16, further comprising a rear cover plate disposed between an outer end surface of the second end of the stator housing and a lower housing, wherein an end portion of the bearing is fitted into a cover plate through hole at a central portion of the rear cover plate.

18. The motor assembly of claim 11, wherein the elastic member comprises an elastic ring sleeved around an outer peripheral wall of the bearing, wherein an upper end of the elastic ring abuts a lower end of a bearing shoulder, a lower end of the elastic ring abuts the stator housing, and a lower end of the bearing is fitted into a housing through-hole at a central portion of the second end of the stator housing.

19. The motor assembly of claim 11, wherein the elastic member is made of metal or rubber.

20. An automotive air vent actuator, comprising:
an upper housing;
a lower housing, the upper housing and the lower housing defining an installation cavity between them;
a motor assembly disposed in the installation cavity, the motor assembly comprising:
a stator assembly, the stator assembly including a stator housing having a first end and a second end; and
a rotor assembly detachably connected to the stator assembly, the rotor assembly having a rotor shaft arranged along a first axis and detachably connected to the stator housing;
a bearing; and
an elastic member positioned near the second end of the stator housing and configured to support the rotor shaft, the elastic member defining a central bearing engagement hole surrounded by a plurality of evenly spaced limiting strips, and a peripheral portion including an annular positioning portion.
wherein the elastic member is configured to cooperate with the bearing and the second end of the stator housing to continuously apply an elastic force along the first axis to the rotor shaft through the bearing.
